(19) United States
(12) Patent Application Publication
(10) Pub. No.: US 2007/0298783 A1
(43) Pub. Date: Dec. 27, 2007

(54) Wireless communication device

(75) Inventors: Chih Hsiung Tseng, Hsinchu City (TW); Shih-Yi Chen, Jhubei City (TW)

Correspondence Address: BIRCH STEWART KOLASCH & BIRCH, PO BOX 747, FALLS CHURCH, VA, 22040-0747, US

(73) Assignee: Accton Technology Corporation

(21) Appl. No.: 11/473,267

(22) Filed: Jun. 23, 2006

(51) Int. Cl. H04Q 7/20

(52) U.S. Cl. 455/425

(57) ABSTRACT

The present invention presents a wireless communication device comprises: a CPU for dealing with the process of the wireless communication device, an RF switch coupled to the CPU for wireless application, at least one wireless transceiver coupled to the RF switch for transmitting and receiving wireless signals, a GPIO (General Purpose Input Output) coupled to the CPU for a variety of connections, and a PCB (printed circuit board) trace connected to the wireless transceiver for providing a function as the 2nd harmonics filter. And the CPU stated above could detect the signal quality of RF signals from the RF transceiver. The indicating element comprises a plurality of LEDs coupled to the GPIO for presenting the signal quality of RF signals detected via CPU. Otherwise, a user interface coupled to the CPU for user control of the wireless communication device. And the device further comprises a housing having the capability of water-proof and wind-resistant. Owing to protect the device from the violent weather, a lightning protection design connected to the wireless transceiver for protection the wireless communication device from lightning.

### FIELD OF THE INVENTION

The present invention relates generally to the wireless application, and more particularly to the wireless communication devices.

### BACKGROUND OF THE INVENTION

Retrospect to technology history of 90's, the Internet growth seems to be the most important thing. The influence of the Internet on people's life is self-evident. Nowadays, because of the sharing feature of the Internet, people don't have to go to a physical place or meet someone personally for obtaining and exchanging information.

According to human's dependence on Internet, advanced technology comes up. This advanced technology is the wireless technology such as IEEE 802.11. It provides the access to Internet service without wires. Owing to the mobile feature of the wireless technology, people acquire incredible efficiency. Even many cities or countries commence giving impetus to build wireless, for instance, Wireless Philadelphia Project, Austin wireless, or Westminster wireless project. It reveals that the wireless technology is gradually becoming embedded in human beings. In the wireless communication, the communication device such as Access Point (AP) plays an important role. Users may transmit and receive data through the Access Points to Internet with their wireless clients. Originally, the wireless communication device is generally placed within the buildings. However, the demand of people using WiFi hand-held devices in outdoor environment becomes stronger and stronger. Accordingly, the wireless communication device needs to be shifted to the outdoors. Accompanying with the change, certain besetments come up. One such problem is exposing under the extreme weather condition, for example, rain permeating, thunderstruck, or wind erosion. This kind of weather would lead to the damage of devices. The present invention addresses such problems to provide a device for wireless communication device.

### SUMMARY OF THE INVENTION

A wireless communication device comprises: a CPU (central processing unit) for handling the process of the wireless communication, an RF switch for wireless application, at least one RF transceiver for transmitting and receiving wireless signals, a GPIO (General Purpose Input Output) coupled to the CPU for a variety of control signals, and a PCB (printed circuit board) trace connected to the wireless transceiver for providing the function as a 2nd harmonics filter and antenna port lightning protector.

The CPU stated above detects the received signal strength of RF signals from the RF transceiver. In order to indicate the signal quality of the wireless communication device, at least one indicating element coupled to the GPIO. And the indicating element comprises a plurality of LED coupled to the GPIO for representing the stat us of RF signals detected via CPU.

Otherwise, a user interface coupled to the CPU provides the console interface to control and maintain the wireless communication device. For locating the wireless communication device outdoors, the device further comprises a housing having the capability of water-proof and wind-resistant. And owing to protect the wireless application device from the violent weather, The housing further comprises a ground and a lightning protection design connected to the wireless transceiver for protection the wireless communication device from lightning.

### BRIEF DESCRIPTION OF THE DRAWINGS

FIG. 1 illustrates the functional diagram according to wireless communication device of the present invention.

FIG. 2 illustrates the principle of ¼ wavelength applied to the present invention.

FIG. 3 provides a experiment data for the principle of ¼ wavelength.

### DETAILED DESCRIPTION OF THE PREFERRED EMBODIMENT

The present invention is described with the preferred embodiments and accompanying drawings. It should be appreciated that all the embodiments are merely used for illustration. Hence, the present invention can also be applied to various embodiments other than the preferred embodiments. Besides, the present invention is not limited to any embodiment but to the appending claims and their equivalents.

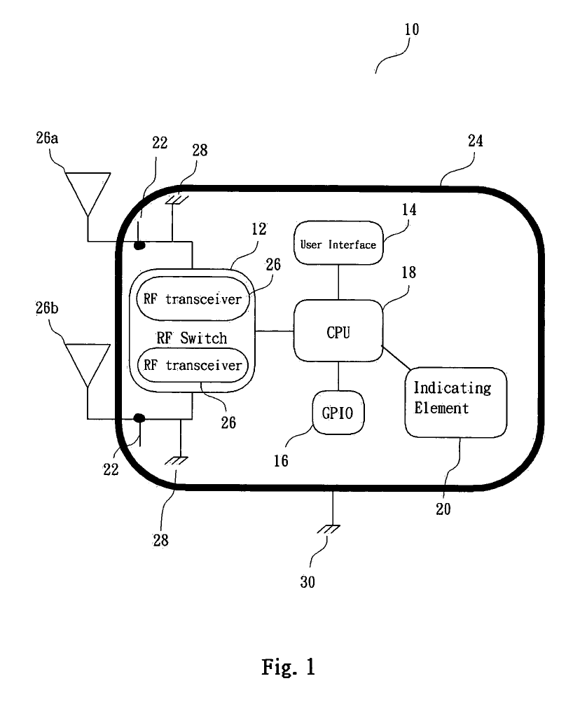

The present invention provides a device for wireless communication. Please refer to FIG. 1, the wireless communication device 10 includes a CPU 18 (central processing unit) for dealing the process of the wireless communication device 10, an RF switch 12 coupled to the CPU 18 for wireless application. The RF switch 12 may be employed to function among the wireless protocols, such as 802.11x, where x is a, b, and g. The RF switch 12 further comprises at least one wireless transceiver 26. The wireless transceiver 26 has at least one antenna, i.e. antenna 26a, antenna 26b in FIG. 1, for transmitting and receiving wireless signals. The antenna 26a and antenna 26b are illustrated for example not limited to the present invention. The wireless transceiver 26 could be 802.11x wireless transceiver. A GPIO 16 (General Purpose Input Output) is coupled to the CPU 18 for a variety of connections, at least one indicating element 20 is coupled to the GPIO 16 for indicating the signal quality of the wireless communication device 10. A user interface 14 is coupled to the CPU 18 for user control of the wireless communication device 10, and a housing 24 having the capability of water-proof and wind-resistant. And the housing has a ground 30 for lighting protecting.

Moreover, the above-mentioned wireless transceiver 26 includes RF transceiver. And the wireless communication device 10 could contain a variety of the wireless transceivers 26 according to different kinds of wireless standards at the same time. For example, the antenna 26a could be the antenna under the 802.11a standard and the antenna 26b could be the antenna under the 802.11b standard. The 11a and 11g RF transceivers are stated for example only. The transceiver 26 could transmit and receive wireless signals with 802.11a and 802.11g protocols according to each standard, respectively. It is appreciated that the FIG. 1 of the present invention provides an example but not limited to IEEE 802.11a or 802.11g.

The CPU 18 could detect the signal quality of RF signals from the RF transceiver 26. In addition, the aforementioned GPIO 16 is coupled to the CPU 18 for a variety of connections, at least one indicating element 20 is coupled to the GPIO 16. The indicating element 20 could comprise a plurality of RSSI (received signal strength indication) LEDs for representing RF signal strength detected via the CPU 18.

And the user interface 14 provides an easy way for the users to dominate the wireless communication device 10. For instance but not limited to, on/off, signal strength present, reset, or hardware failure message. Otherwise, a housing 24 would adopt the material of water-proof and wind-resistant that one skilled in the relevant art recognizes.

Additionally, the wireless communication device further comprises a lightning protection element 28, the characteristic of the element 28 is that for surge, the distance from the element to ground is the shortest path than the path of other components in the device. It is open circuits to the operation bands. Thus, the surge energy will be discharged via the path. And the lightning protection element 28 could discharge via the ground pad in the internal of the device or through the shell or the house of the device to the ground. The lightning protection element 28 is coupled to the wireless transceiver 26 for protection the wireless communication device 10 from lightning. The designs utilize the principle of ¼ wavelength. One skilled in the relevant art will recognize.

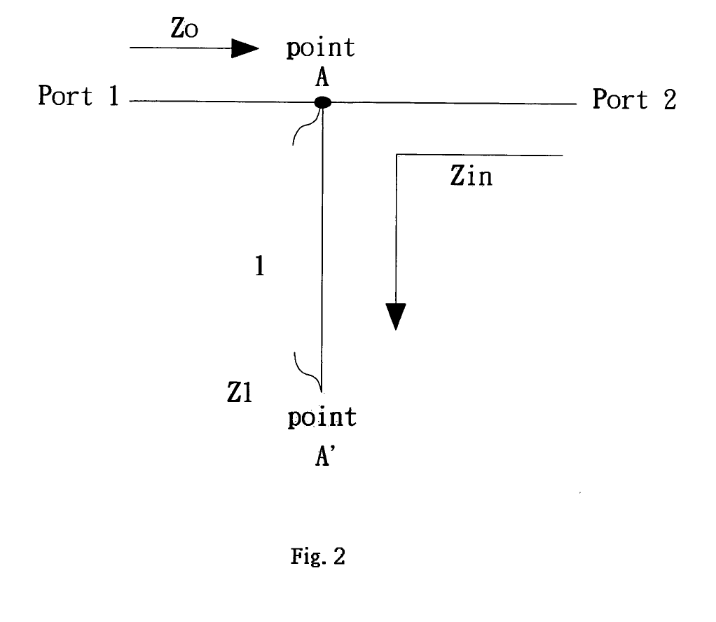

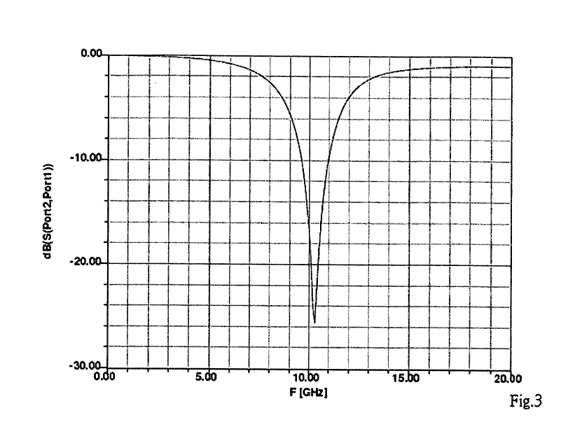

A conductive trace 22 may be formed on the PCB (printed circuit board) at the attached node between the transceiver 26 and the antenna 26a. The trace 22 is connected to the wireless transceiver 26 for providing a function as the 2nd harmonics filter. The length of the trace 22 is approximately ¼ wavelength of the filtering frequency. The designs utilize the principle of ¼ wavelength. One skilled in the relevant art will recognize. The band of operation frequency, for example 802.11a, is approximately 4.9 to 5.825 GHz, and the filtering frequency is two times of the operation band, namely, it is around 9.8 to 11.65 GHz. The conductive trace or the 2nd harmonics filter may filter out the frequency around 9.8 to 11.65 GHz. FIG. 2 illustrates the operation of the principle of ¼ wavelength of the signal for the 2nd harmonics filter in rough. Further, FIG. 3 provides an experiment data for the above-mentioned principle. From the data, the dB value of the frequency in the range around 9.5-11.5 GHz is dramatically drop to lower than −20 dB. It means that the 2nd harmonics filter can effectively filters out the frequency.

Input impedance of quarter wavelength open stub:

$$Zin = Zo \frac{Zl + jZo tan ( Bl )}{Zo + jZl tan ( Bl )} ;$$

wherein the Zin represents the impedance from port 2 to point A′;
the Zo presents the initial impedance of the Zin,;
the Zl presents the impedance from point A to A′.
And

$$B = \frac{2 π}{λ} ,$$

### Zl→∞ (because of the open circuit),

if

$$1 = \frac{λ}{4} ,$$

λ is the wavelength of 2nd harmonic frequency.
Then

$$B 1 = \frac{π}{2}$$

and Zin can be simplified as Zin=0.
It represents that 2nd harmonic signal sees a short circuit as it encounters the quarter wavelength open stub. Theoretically, the reflection coefficient, Γ, is:

$$Γ = \frac{Zl - Zo}{Zl + Zo} = \frac{0 - Zo}{0 + Zo} = - 1$$

It means that total reflection occurs and 2nd harmonic signal can not pass from port 1 to port 2. So, the principle of ¼ wavelength of wave may apply to the PCB trace and this design could save the cost for extra components to be 2nd harmonic filter.

From the foregoing, it will be appreciated that specific embodiments of the invention have been described herein for purposes of illustration, but that various modifications may be made without deviating from the spirit and scope of the invention. Accordingly, the invention is not limited except as by the appended claims.

We claim:

1. A wireless communication device comprising:
a CPU for dealing the process of said wireless communication device;
a RF switch coupled to said CPU for wireless application;
said RF switch comprises at least one wireless transceiver for transmitting and receiving wireless signals;
an antenna coupled to said wireless transceiver for assisting said wireless transceiver in transmitting and receiving wireless signals;
a GPIO (General Purpose Input Output) coupled to said CPU for a variety of connections.

2. The wireless communication device as set forth in claim 1, wherein said wireless transceiver includes RF transceiver.

3. The wireless communication device as set forth in claim 2, wherein said CPU could detect the measures of RF signals from said RF transceiver.

4. The wireless communication device as set forth in claim 1, further comprising at least one indicating element coupled to said GPIO for indicating the status of said wireless communication device.

5. The wireless communication device as set forth in claim 4, wherein said at least one indicating element comprises a plurality of LED coupled to said GPIO for presenting the measures of RF signals detected via CPU.

6. The wireless communication device as set forth in claim 4, wherein said at least one indicating element comprises a RSSI (received signal strength indication).

7. The wireless communication device as set forth in claim 1, further comprising a user interface coupled to said CPU for a user determines and controllers the state of said wireless communication device.

8. The wireless communication device as set forth in claim 1, further comprising a housing having the capability of water-proof and wind-resistant.

9. A wireless communication device comprising:
a CPU (central processing unit) for dealing the process of said wireless communication device;
a RF switch coupled to said CPU for wireless application;
said RF switch comprises at least one wireless transceiver for transmitting and receiving wireless signals;
an antenna coupled to said wireless transceiver for assisting said wireless transceiver in transmitting and receiving wireless signals;
a lightning protection element connected to said wireless transceiver for protection said wireless communication device from lightning.

10. The wireless communication device as set forth in claim 9, further comprising a housing having the capability of water-proof and wind-resistant.

11. The wireless communication device as set forth in claim 9, wherein the distance from said lightning protection element to ground is the shortest path than the path of other components in said wireless communication device.

12. A wireless communication device comprises:
a CPU (central processing unit) for dealing the process of said wireless communication device;
a RF switch coupled to said CPU for wireless application;
said RF switch comprises at least one wireless transceiver for transmitting and receiving wireless signals;
an antenna coupled to said wireless transceiver for assisting said wireless transceiver in transmitting and receiving wireless signals;
a conductive trace formed on a PCB (printed circuit board) of said wireless communication device and connected to said wireless transceiver for serving as 2nd harmonics filter.

13. The wireless communication device as set forth in claim 12, further comprising a housing having the capability of water-proof and wind-resistant.

14. The wireless communication device as set forth in claim 12, the length of said conductive trace is approximately ¼ wavelength of wave received by said at least one wireless transceiver.

15. The wireless communication device as set forth in claim 11, wherein said conductive trace is an open stub.

16. The wireless communication device as set forth in claim 12, wherein said conductive trace is located at the node between said at least one wireless transceiver and said antenna.
